(19) United States
(12) Patent Application Publication
(10) Pub. No.: US 2006/0261572 A1
(43) Pub. Date: Nov. 23, 2006

(54) Pneumatic cylinder device for trailer or semitrailer vehicles

(76) Inventors: Armando Biondi, Sala Bolognese (IT); Paolo Martini, Avesa (IT)

Correspondence Address: GREENBERG TRAURIG LLP, 2450 COLORADO AVENUE, SUITE 400E, SANTA MONICA, CA, 90404, US

(21) Appl. No.: 10/556,327

(22) PCT Filed: May 19, 2004
(86) PCT No.: PCT/IT04/00288

§ 371 Date: Jul. 5, 2006

(30) Foreign Application Priority Data
May 19, 2003 (IT) VR2003A000061

(51) Int. Cl. B62D 53/06

(52) U.S. Cl. 280/432

(57) ABSTRACT

A pneumatic cylinder device (10) for trailer or semitrailer vehicles which, according to the angle of rotation between the truck (46) and the semi-trailer (35) or between the tractor (47) and the trailer (48), assumes an angular position which transmits the command for power assisted steering of the wheels on the steering or self-steering axle of the respective semi-trailer (35) or trailer (48) the pneumatic cylinder (11) is a single-action device and a base (24), the end of the latter attached to an additional pin (28) fixed on a semi-trailer (35) or, respectively, on a trailer (48), the cylinder (11) housing a piston (21) which slides along the cylinder and a rod (14; 26) connected to the piston (21), the rod (14; 26) acting as a longitudinally extending and transversally rigid tie rod for the presence of pressurised air supplied to the inside of the cylinder through a supply hole (23).

### TECHNICAL FIELD

The present invention relates to a pneumatic cylinder device for trailer or semitrailer vehicles which, according to the angle of rotation between the truck and the semi-trailer or between the tractor and the trailer, assumes an angular position which transmits the command for power assisted steering of the wheels on the steering or self-steering axle of the respective semi-trailer or trailer.

More particularly, the present invention relates to a pneumatic cylinder device which has a structure that overcomes the problem of limited space typical of the fifth wheel coupling operating zone on the semi-trailer or the towing hitch on the trailer and is such that it can be connected on the semi-trailer or the trailer and connected, at will, using a quick coupling, to the truck's fifth wheel coupling or to the tractor's hitch and inserted in hydraulic or electrical applications such as wheel steering on one or more steering or self-steering axles of articulated vehicles consisting of a truck or tractor which tows the semi-trailer or trailer.

The invention is mainly applied in the engineering industry, agriculture and transport.

### BACKGROUND ART

It is known that an articulated vehicle consisting of a truck or tractor towing a semi-trailer or trailer uses, on the latter, one or two self-steering axles to allow greater manoeuvrability when the articulated vehicle is moving forward.

For articulated vehicle steering while reversing the self-steering axle is locked with the wheels in the straight driving position to avoid the wheels, if they were free to turn, from positioning themselves at an angle and so preventing the articulated vehicle from reversing.

The self-steering axle is fitted with a mechanical—pneumatic or mechanical—hydraulic locking device, normally consisting of a pin which goes into a hole, holding the wheels in the non-steering condition, activated automatically or deliberately by the driver when reverse gear is selected.

Solutions relating to steering self-steering axles with controlled reversing on articulated vehicles have already been proposed. See for example Italian patent application BO94A000174 and European patent application EP-A-678440, in which the electronic device which detects the angle of rotation between the truck and semi-trailer is of the encoder or potentiometric transducer type, incorporated in the semi-trailer towing pin.

This device may be applied to articulated vehicles consisting of a tractor which tows a semi-trailer, connected to one another by a fifth wheel coupling which is integral with the tractor, designed to receive a pin mounted on the semi-trailer.

This type of solution places delicate electronic components in a very dirty area covered by a mixture of mud, water and grease, and weakens the towing pin on the semi-trailer, towed by the fifth wheel coupling, considered a vehicle safety part.

### DISCLOSURE OF THE INVENTION

The present invention proposes to make available a pneumatic cylinder device for articulated vehicles which can overcome or significantly reduce the above-mentioned disadvantages.

More specifically, the present invention proposes to provide a pneumatic cylinder device for articulated vehicles which, according to the angle of rotation between the truck or, respectively, the tractor and the semi-trailer or, respectively, the trailer, can transmit the command for power assisted steering of the wheels on the axle of the semi-trailer or, respectively, the trailer.

Another aim of the present invention is to provide a pneumatic cylinder device which can be positioned on the semi-trailer or the trailer, which is fitted not only with the controlled axle but with all the rest of the articulated vehicle hydraulic or electrical steering circuit.

A further aim of the present invention is to provide a pneumatic cylinder device which can be used for applications in which transmission of the command to the articulated vehicle hydraulic or electrical power steering system occurs mechanically or electronically or electromechanically.

This is achieved with a controlled steering device for the trailers and semi-trailers of tractor trucks with the characteristics described in the main claim.

The dependent claims describe advantageous embodiments of the invention.

According to a particularly advantageous embodiment of the present invention, the pneumatic cylinder device may be applied to any articulated vehicle in production and on the roads, since it does not require any modification to the truck or tractor, nor to the towing pin on the semi-trailer or trailer. According to the invention, it is sufficient to prepare, outside the existing dimensions, a simple bracket on the truck fifth wheel coupling or on the tractor towing hitch and a bracket on the semi-trailer or the trailer.

According to another advantageous embodiment of the invention, the pneumatic cylinder device does not interfere with the manoeuvre for connection and disconnection of the truck or tractor and the semi-trailer or respectively the trailer, since the device has a quick coupling for connection and disconnection.

The pneumatic cylinder device according to the present invention comprises a single-action pneumatic cylinder which acts as a longitudinally extending and transversally rigid tie rod for the presence of pressurised air, in constant communication with the vehicle's pneumatic circuit.

At the ends of the cylinder, with rotary connections, the end of the rod is attached to the end of a bracket fixed to the fifth wheel coupling or to the towing hitch, and the cylinder base end is attached to an additional pin fixed on the semi-trailer or trailer, so that rotation of the fifth wheel coupling or towing hitch relative to the fifth wheel coupling pin or the towing eye of the drawbar, and so of the truck or tractor relative to the semi-trailer or trailer, produces a corresponding angular movement of the pneumatic cylinder relative to its axis at the cylinder base end, designed to be transformed on the axis into an electrical signal with the application of an angular transducer element or into a corresponding mechanical movement to control the rotary or axial hydraulic distributor directly or indirectly by means of a flexible cable or chain or tie rod or another angular transmission part, etc.

### BRIEF DESCRIPTION OF THE DRAWINGS

Other features and advantages of the invention are evident in the description which follows, with reference to the accompanying drawings, which illustrate a preferred embodiment of the invention without limiting the scope of the inventive concept, and in which:

FIG. 1 is a longitudinal section of the device in accordance with the invention, applied on an articulated vehicle consisting of a truck and semi-trailer;

FIG. 1a is a schematic plan view of the device illustrated in FIG. 1;

FIG. 1b is an enlarged illustration of the fifth wheel coupling side of FIG. 1;

FIG. 1c is an enlarged illustration of the semi-trailer side of FIG. 1, the device illustrated in a shortened form to make it easier to understand the most important details;

FIG. 2 is a longitudinal section of the device in accordance with the invention, applied on an articulated vehicle consisting of a tractor and a trailer;

FIG. 2a is a schematic plan view of the device illustrated in FIG. 2;

FIG. 3a is a longitudinal partial enlarged section of the fifth wheel coupling side of a variant of the invention applied on an articulated vehicle consisting of a truck and a semi-trailer;

FIG. 3b is a view similar to the view in FIG. 3a, of the semi-trailer side;

FIGS. 4 to 13 are functional schematic plan views of several embodiments with different uses of a device in accordance with the present invention, in particular on an articulated vehicle comprising a truck or tractor and a semi-trailer or trailer.

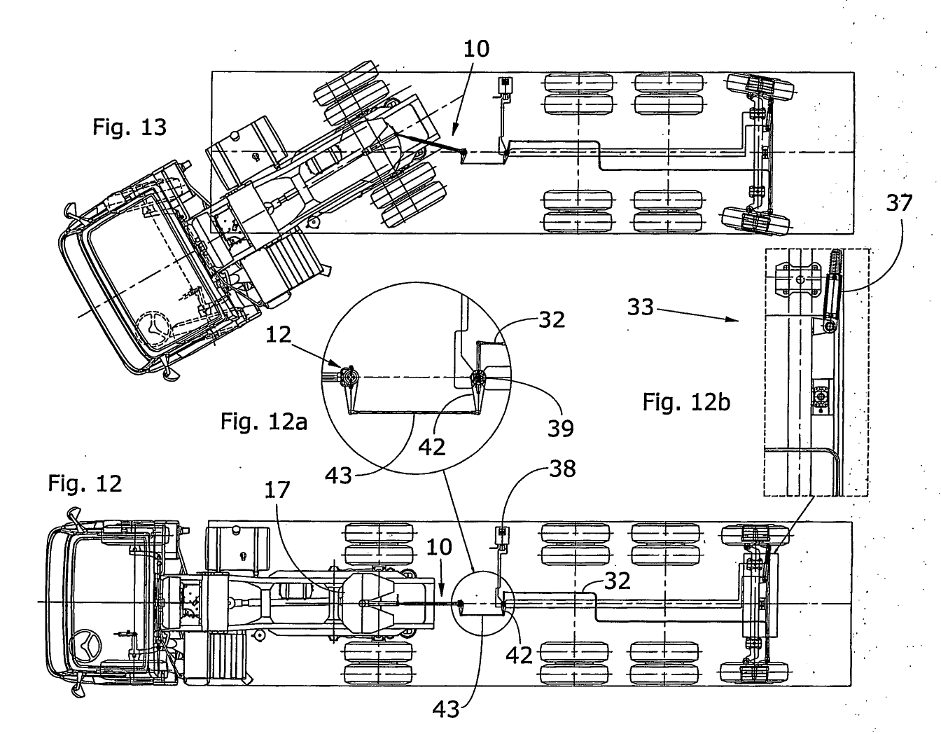

In particular, FIGS. 4, 6, 8, 10, 12 illustrate a vehicle equipped with the device disclosed, in a position with the wheels straight, whilst FIGS. 5, 7, 9, 11, 13 illustrate the corresponding vehicle in a position with the wheels steered.

Moreover, in more detail:

in FIGS. 4, 4a, 4b, 5, 6, 6a, 6b, 7 the transmission lever which controls the hydraulic distribution that operates the steering or self-steering axle controlled is positioned on the axis of rotation of the cylinder base, to receive the angular movement generated by rotation of the fifth wheel coupling or the towing hitch relative to the semi-trailer or the trailer;

in FIGS. 8, 8a, 8b, 9 the rotary hydraulic distributor which operates the steering or self-steering axle controlled is positioned on the axis of rotation of the cylinder base, to receive the angular movement generated by rotation of the fifth wheel coupling relative to the semi-trailer;

in FIGS. 10, 10a, 10b, 11 the angular transducer for controlling the hydraulic distribution which operates the steering or self-steering axle controlled is positioned on the axis of rotation of the cylinder base, to receive the angular movement generated by rotation of the fifth wheel coupling relative to the semi-trailer; and

in FIGS. 12, 12a, 12b, 13 the transmission lever for rotation of a new axle on which, as required, the transmission lever illustrated in FIGS. 4 to 7, or the rotary hydraulic distributor illustrated in FIGS. 8 and 9, or the angular transducer illustrated in FIGS. 10 and 11 is located, is positioned on the axis of rotation of the cylinder base, to receive the angular movement generated by rotation of the fifth wheel coupling relative to the semi-trailer.

### DETAILED DESCRIPTION OF THE PREFERRED EMBODIMENTS OF THE INVENTION

In the figures, the reference number 10 denotes a device for obtaining power assisted controlled steering of the wheels on the steering or self-steering axle of a semi-trailer or trailer or towed carriage of a truck or tractor for industrial and/or agricultural and/or transport use.

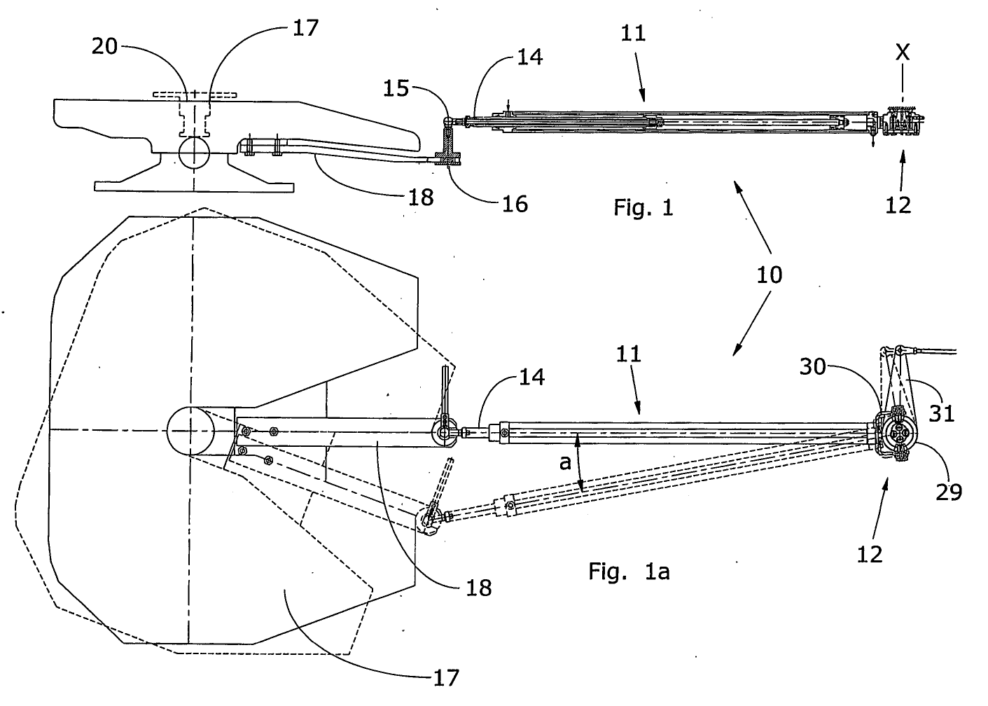

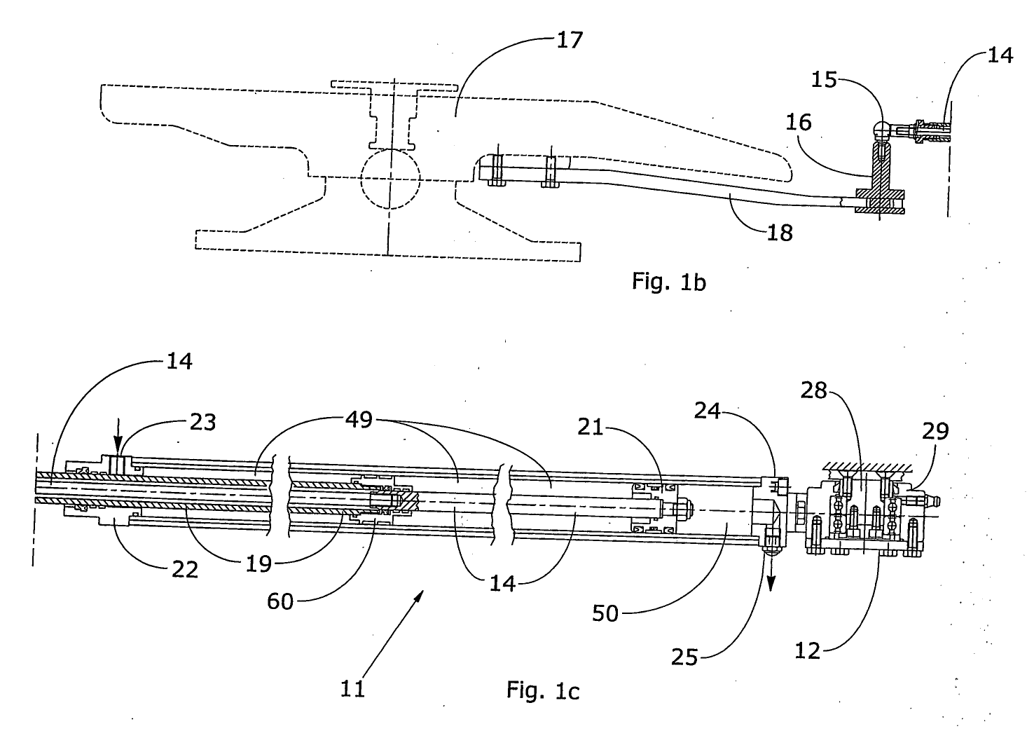

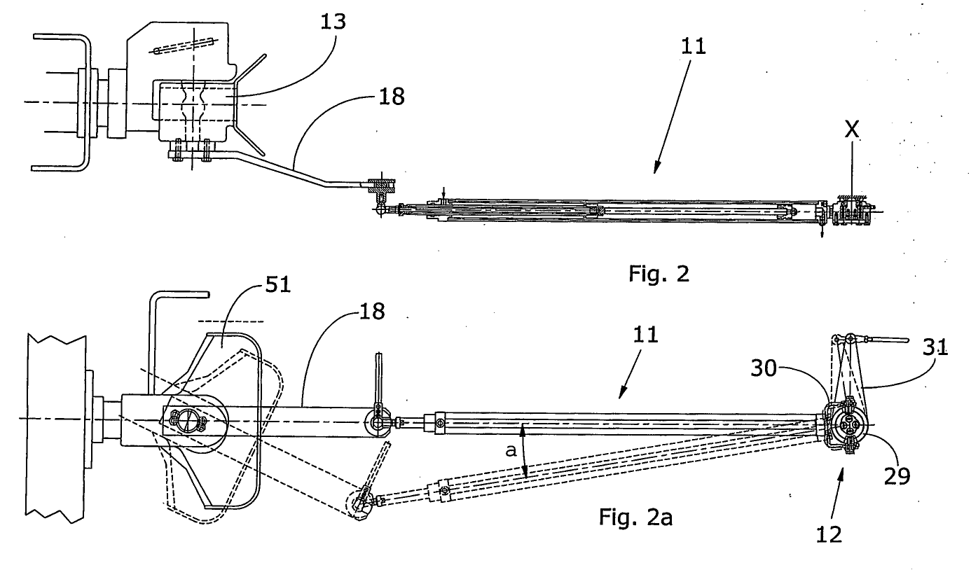

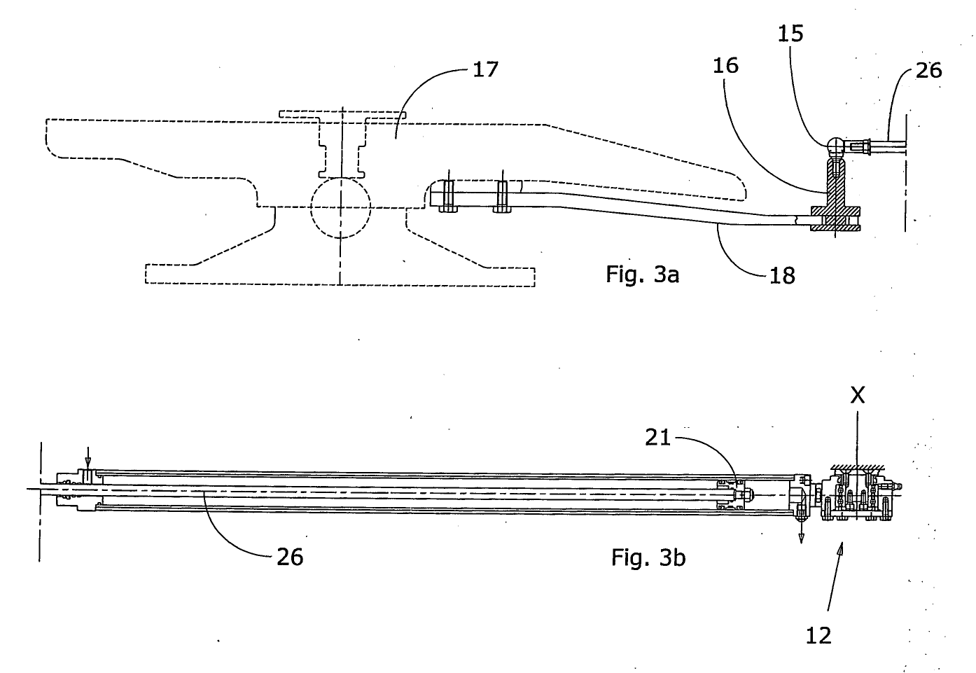

With reference first to FIGS. 1 and 1a, 1b, 1c it should be noticed that the device 10 consists of a single-action pneumatic cylinder 11 which acts as a longitudinally extending and transversally rigid tie rod for the presence of pressurised air, having a first chamber 49 communicating through a hole 23 with a respective pneumatic circuit acting on a piston 21. The cylinder 11 is closed at one end by a head 22 through which a structure runs, the latter consisting of a first, hollow, external rod 19 in which a second, internal rod 14 runs.

The cylinder 11 also comprises a chamber 50 communicating with the outside through an air bleed hole 25 at the base 24 of the cylinder.

In accordance with an important feature of the invention, the device 10 allows connection with rotary coupling between:

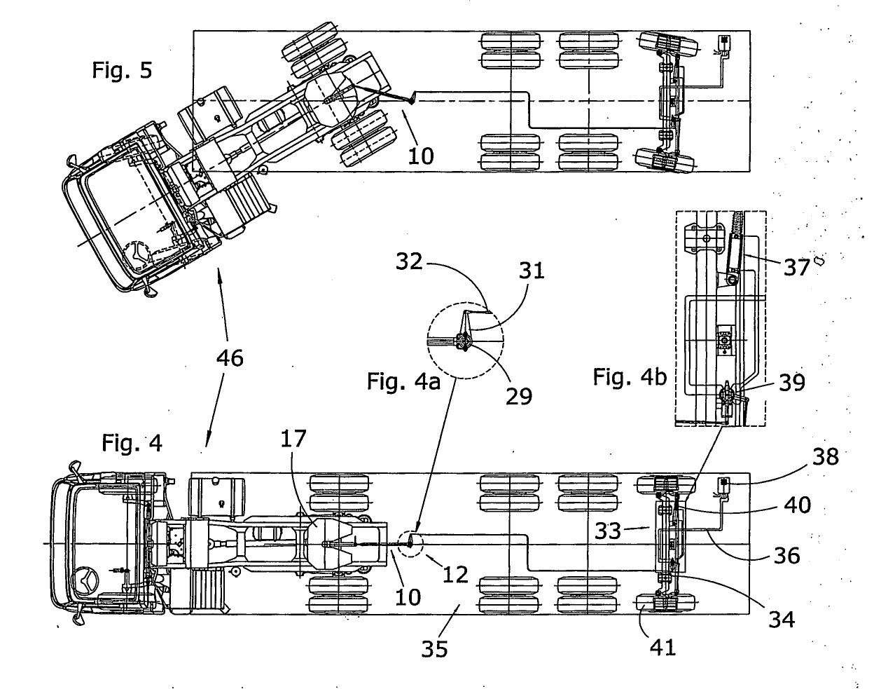

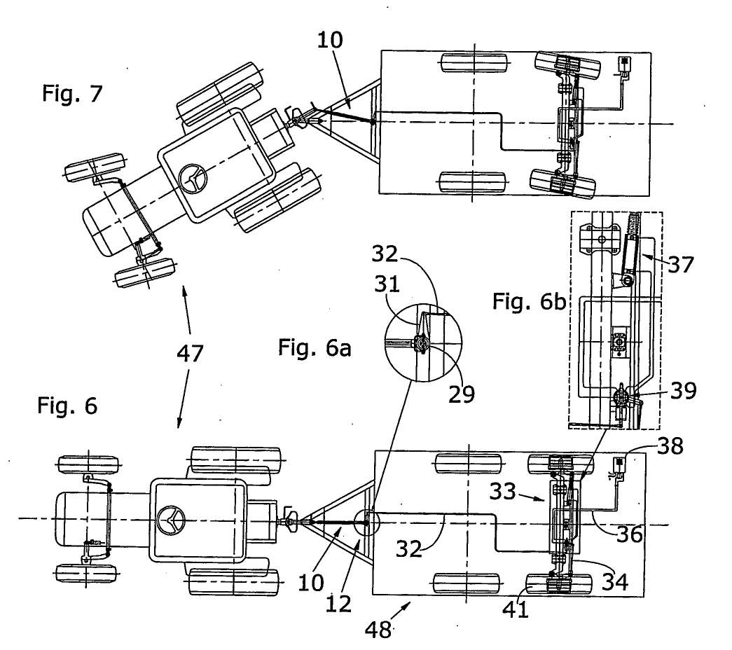

the end of the rod 14 and the end of a bracket 18 fixed on the fifth wheel coupling 17 (FIG. 1b) or on the towing hitch 51 (FIG. 2a); and

the cylinder base 24 end and an additional pin 28 fixed on the semi-trailer 35 (FIG. 4) or the trailer 48 (FIG. 6).

A swivel head 15 (FIG. 1b) fixes the end of the internal rod 14 to a quick coupling 16 and allows suitable vertical oscillation between the pneumatic cylinder 11 and the bracket 18 fixed on the fifth wheel coupling or on the towing hitch.

According to a particularly advantageous embodiment of the invention, the pneumatic cylinder 11 incorporates two rods, one inside the other, where the internal rod 14, normally made of high strength steel and allowing slight and useful elastic flexing, is pulled out by the bracket 18 on the fifth wheel coupling 17 or on the towing hitch 51 and in by the pneumatic pressure on the piston 21, to which the rod 14 is connected.

According to the invention, the diameter and length of the two rods are proportional to one another so that the pneumatic pressure in the cylinder 11 chamber 49 keeps them integral and rigid for the entire external rod 19 stroke which corresponds to the part of the angular movement a of the pneumatic cylinder 11 active when steering the wheels 41 on the steering or self-steering axle 34 of the semi-trailer or trailer.

Then (see FIGS. 1a, 2a), after the external rod 19 has come out completely, the pressure allows the entire remaining outward stroke of the internal rod 14 corresponding to a large angle of rotation a between the truck 46 or the tractor 47 and the semi-trailer 35 or the trailer 48, in which steering of the wheels 41 on the steering or self-steering axle 34 of the semi-trailer or trailer is constantly kept in the maximum steering angle position.

According to the invention, fixed to the two ends of the hollow rigid external rod 19 there are two bushings which guide the internal rod 14. The latter, remaining rigid due to the positive effect of the traction created by the pneumatic pressure, has a small diameter, for example just 8 mm.

This particular feature allows the internal rod 14 to be inserted in limited spaces and so allows the production of a pneumatic cylinder device 10 with a long stroke but extremely compact width and thickness.

According to a particularly advantageous embodiment of the invention (see FIGS. 1c and 2a), the pneumatic cylinder 11 has a base 24, closing the cylinder at the end opposite the rod outlet, the base being integral with a fork 30 which is connected, with coupling that allows suitable vertical oscillation, to the rotary body 29 of an additional pin 28 fixed on the semi-trailer 35 or on the trailer 48.

The additional pin 28 fixed on the semi-trailer 35 or on the trailer 48 has bearings to support its rotary body 29, to which the following may be fixed, according to different embodiments:

a transmission lever 31, or

a rotary hydraulic distributor 39, or

an angular transducer 44 for controlling the hydraulic distribution or an electrical actuator for steering the wheels 41 on the steering or self-steering axle 34 of the semi-trailer or trailer.

Rotation of the fifth wheel coupling 17 or of the towing hitch 51 relative to the fifth wheel coupling pin 20 or relative to the drawbar towing eye 13 and so, rotation of the truck 46 or the tractor 47 relative to the semi-trailer 35 or respectively the trailer 48, produces a corresponding angular movement a of the pneumatic cylinder 11 relative to its axis X at the end 12 of the cylinder base 24.

The pneumatic cylinder 11 angular movement a is designed to be transformed on its axis X at the end 12 of the cylinder base 24:

by application of an angular transducer element 44, into a corresponding electrical signal for controlling the hydraulic distribution 27 which operates steering of the wheels on the steering or self-steering axle 34 of the semi-trailer or trailer, as illustrated in FIGS. 10, 10a, 10b, 11;

by application of an angular transmission lever 31, into a corresponding mechanical control movement, using a flexible cable 32 or a chain or tie rod or another angular transmission part 42, etc., for the hydraulic distributor 39 for steering the wheels 41 on the steering or self-steering axle 34 of the semi-trailer or trailer, as illustrated in FIGS. 4, 4a, 4b, 5, 6, 6a, 6b, 7, 12, 12a, 12b, 13;

by coaxial application of a rotary hydraulic distributor 39, into a steering action for the wheels 41 on the steering or self-steering axle 34 of the semi-trailer or trailer, as illustrated in FIGS. 8, 8a, 8b, 9.

The steering unit 33 normally comprises a hydraulic circuit 36 with a double-action linear actuator 37, a pump or electrical pump 38, with oil reservoir, designed to supply the circuit 36 at the required pressure and a hydraulic distributor 39, for example of the rotary type.

The actuator 37 rod 40 is kinematically connected, to the lever for rotation of the wheels 41 on the steering or self-steering axle 34.

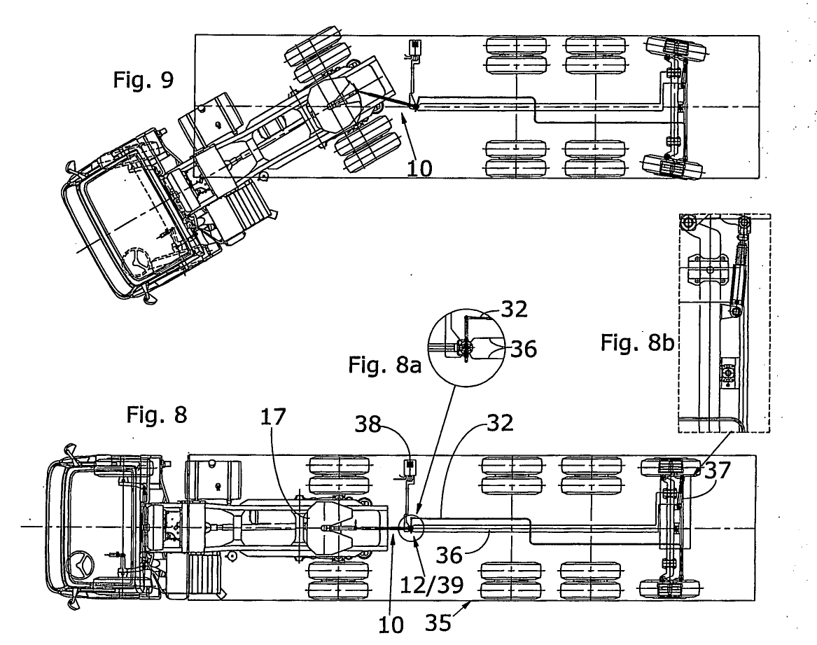

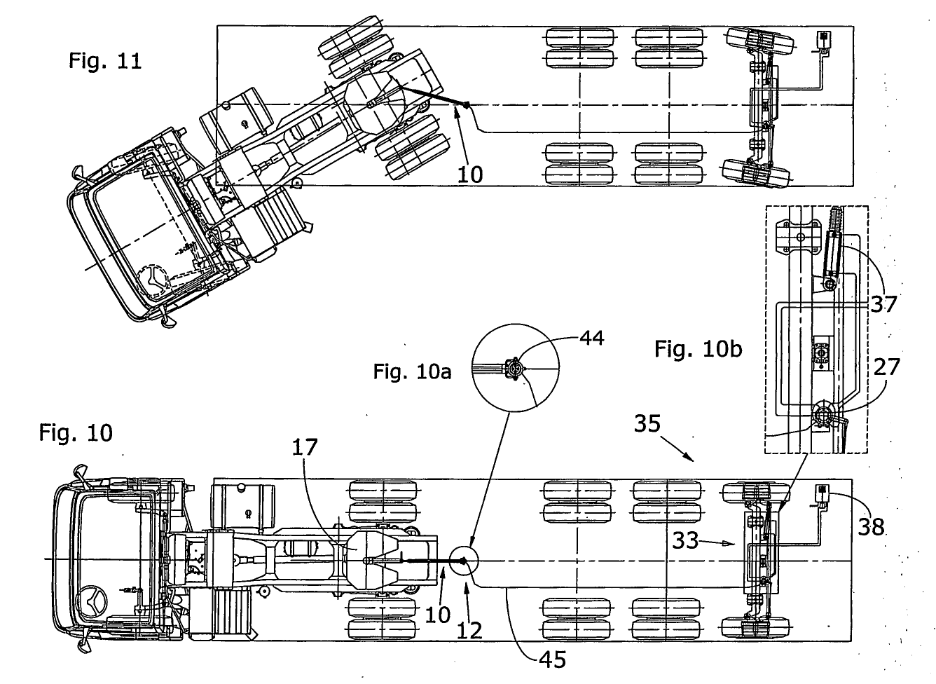

According to an alternative embodiment illustrated in FIGS. 3a, 3b, particularly for use on agricultural vehicles, when application requirements allow larger dimensions, the device 10 may comprise a cylinder 11 with a single rod 26, with a diameter bigger than that of the above-mentioned internal rod 14.

Said single rod 26, providing greater stiffness, may sometimes allow the supply of pressurised air to be dispensed with.

It should be noticed that the piston 21 is fitted with retaining means so that it can both push and pull the rod 14.

Moreover, the piston 21 has a magnetic ring for controlling magnetic switches positioned outside the cylinder, for checking the angular rotation between the truck 46 and semi-trailer 35 or between the tractor 47 and trailer 48.

Therefore, the device 10 for power assisted controlled steering disclosed achieves all of the preset aims. In particular, it may be applied to any type of tractor and towing vehicle without any modifications to the existing connecting means.

Moreover, thanks to the combination of hydraulic and mechanical or hydraulic and electrical technologies, the device 10 guarantees extreme reliability and readiness, unaffected by the conditions of the working environment.

The invention was described above with reference to several preferred embodiments.

However, obviously the invention may have many other variants which achieve the preset aims, all technically equivalent.

1. Pneumatic cylinder device for trailer or semitrailer vehicles which, according to the angle of rotation between the truck and semi-trailer or the tractor and the trailer, assumes an angular position which transmits the command for power assisted steering of the wheels on the steering or self-steering axle of the respective semi-trailer or trailer, characterised in that the pneumatic cylinder is a single-action device and comprises an extended cylindrical body with a head and a base, the end of the latter being attached to an additional pin fixed on a semi-trailer or, respectively, on a trailer, the cylinder housing a piston which slides along the cylinder and a rod connected to the piston, also comprising a supply hole communicating with a circuit designed to supply pressurised air into a first chamber formed between the piston and the head, and a second, air bleed hole communicating with a second chamber formed between the piston and the base, in which the rod passes through the head (22), the end of the rod being attached, with a rotary connection, to the end of a bracket, fixed on a fifth wheel coupling or, respectively, on a towing hitch, the rod acting as a longitudinally extending and transversally rigid tie rod for the presence of pressurised air supplied to the inside of the cylinder through the supply hole.

2. The device according to claim 1, wherein the rod runs inside another, hollow rod in turn slidably mounted, using suitable guide means.

3. The device according to claim 2, wherein the other, hollow rod comes out through the head.

4. The device (10) according to claim 1, wherein the rotation of the fifth wheel coupling or, respectively, of the towing hitch relative to the fifth wheel coupling pin or, respectively, to the drawbar towing eye, and so rotation of the truck or, respectively, the tractor relative to the semi-trailer or, respectively, the trailer produces an angular movement of the pneumatic cylinder relative to its axis at the base end.

5. The device according to claim 4, wherein the angular movement of the pneumatic cylinder is designed to be transformed, on its axis at the base end by application of an angular transducer element, into a corresponding electrical signal for controlling the hydraulic distribution which operates steering of the wheels on the steering or self-steering axle of the semi-trailer or trailer.

6. The device of claim 1 wherein the angular movement of the pneumatic cylinder is designed to be transformed, on its axis at the base end, by application of an angular transmission lever, into a corresponding mechanical control movement, using a flexible cable or a chain or tie rod or another angular transmission part for the hydraulic distributor for steering the wheels on the steering or self-steering axle of the semi-trailer or trailer.

7. The device of claim 1 wherein the angular movement of the pneumatic cylinder is designed to be transformed on its axis at the base end by coaxial application of a rotary hydraulic distributor into a steering action for the wheels on the steering or self-steering axle of the semi-trailer or trailer.

8. The device of claim 1 wherein the it controls a steering unit, comprising a hydraulic circuit with a pump or electrical pump with oil reservoir, a distributor and a double-action hydraulic linear actuator.

9. The device of claim 1 wherein the bracket is fixed on the fifth wheel coupling or on the respective towing hitch in a position such that it does not obstruct disconnection of the truck or the tractor from the semi-trailer or the trailer and characterised in that all of the remaining part is positioned on the semi-trailer or trailer on which it is installed, not only the axle controlled but also all the remaining hydraulic steering circuit.

10. The device of claim 1 wherein it comprises a quick coupling for connection and disconnection of the pneumatic cylinder and the bracket fixed on the fifth wheel coupling or on the respective towing hitch.

11. The device of claim 1 wherein it has a swivel head which secures the end of the internal rod to the quick coupling, allowing suitable vertical oscillation between the pneumatic cylinder and the bracket fixed on the fifth wheel coupling or on the respective towing hitch.

12. The device of claim 2 wherein the internal rod, made of high strength steel with elasticity allowing slight and useful elastic flexing, is pulled out by the bracket on the fifth wheel coupling or on the respective towing hitch, and in by the pneumatic pressure on the piston, to which the rod is connected, the diameter and length of the two rods being proportional to one another so that the pneumatic pressure in the cylinder chamber keeps them integral and rigid for the entire external rod stroke which corresponds to the part of the angular movement of the pneumatic cylinder active when steering the wheels on the steering or self-steering axle of the semi-trailer or trailer, and characterised in that after the external rod has come out completely, the pressure allows the entire remaining internal rod outward stroke, corresponding to a large angle of rotation between the truck or, respectively, the tractor and the semi-trailer or, respectively, the trailer, in which steering of the wheels on the steering or self-steering axle of the semi-trailer or trailer is constantly kept in the maximum steering angle position.

13. The device of claim 2 wherein there are two bushings fixed to the two ends of the hollow rigid external rod for guiding the internal rod.

14. The device of claim 2 wherein the base is integral with the fork which is connected, with coupling that allows suitable vertical oscillation, to the rotary body of the additional pin fixed on the semi-trailer or, respectively, on the trailer.

15. The device of claim 1 wherein the additional pin fixed on the semi-trailer or on the trailer has bearings to support its rotary body to which the following are fixed: a transmission lever; or a rotary hydraulic distributor; or an angular transducer for controlling the hydraulic distribution or an electrical actuator for steering the wheels on the steering or self-steering axle of the semi-trailer or trailer.

16. The device of claim 1 wherein it comprises a single rod pulled out by the bracket on the fifth wheel coupling or on the towing hitch and in by the pneumatic pressure on its piston.

17. The device of claim 1 wherein it comprises a single rod pulled out and pushed in by the bracket on the fifth wheel coupling or on the towing hitch.

18. The device of claim 1 wherein the piston is fitted with retaining means so that it can both push and pull the rod.

19. The device of claim 1 wherein the piston has a magnetic ring for controlling magnetic switches positioned outside the cylinder, for checking the angular rotation, between the truck and the semi-trailer or between the tractor and the trailer.
